(19) United States
(12) Patent Application Publication
(10) Pub. No.: US 2010/0307601 A1
(43) Pub. Date: Dec. 9, 2010

(54) METHOD AND DEVICE FOR CONDITIONING A SUSPENSION CONTAINING MAGNETIZABLE PARTICLES

(76) Inventors: Claus Gabriel, Griesheim (DE); Günter Oetter, Frankenthal (DE); Christoffer Kieburg, Maxdorf (DE); Jürgen Pfister, Speyer (DE); Martin Laun, Mannheim (DE)

Correspondence Address: CONNOLLY BOVE LODGE & HUTZ, LLP, P O BOX 2207, WILMINGTON, DE, 19899, US

(21) Appl. No.: 12/745,627

(22) PCT Filed: Nov. 25, 2008
(86) PCT No.: PCT/EP08/66164

§ 371 Date: Jun. 1, 2010

(30) Foreign Application Priority Data
Nov. 30, 2007 (EP) 07121960.4

(51) Int. Cl. F17D 1/16; F15C 4/00

(52) U.S. Cl. 137/13; 137/827; 137/833

(57) ABSTRACT

Methods comprising: providing a suspension comprising magnetizable particles; and delivering the suspension through a gap (3), wherein a magnetic field is applied in the gap, such that the suspension is sheared in the gap in the presence of the magnetic field to form a conditioned suspension; and devices for conditioning suspensions containing magnetizable particles, the device comprising a gap (3) through which the suspension containing magnetizable particles flows and in which a shear force is applied to the suspension containing magnetizable particles, wherein the device furthermore contains a magnet for generating a magnetic field in the gap (3).

The invention relates to a method for conditioning a suspension containing magnetizable particles. The invention furthermore relates to a device for conditioning suspensions containing magnetizable particles.

Suspensions containing magnetizable particles are used for a very wide variety of purposes. For example, such liquids are used as magnetic coating agents for magnetic storage media. Other fields of application involve use as sealing liquids or as magnetorheological liquids. The suspensions containing magnetizable particles conventionally contain a base liquid, magnetizable particles, dispersants and thixotropic agents.

The quality of the suspension is commensurately better when the magnetizable particles are better separated from one another and when the particles in the suspension are covered with dispersants on the particle surface. Essential properties of the suspension containing magnetizable particles, in particular viscosity and quality of the suspensions, are affected by this. If the suspension consists of components with very different polarity, surface-active substances are often added. Micelles, membranes and surfactant multilayers may also be formed depending on the quantity and surface area ratios.

In order to improve the sedimentation stability of the magnetizable particles in the suspension, it is known for example from U.S. Pat. No. 6,203,717 to add organomineral clay to a magnetorheological liquid. A high shear stress is applied to the suspension in order to delaminate the organomineral clay.

In order to bring particles in a magnetorheological liquid to a uniform size, it is known from US-A 2004/0050430 to shear the liquid with the particles which it contains in a gap. To this end the liquid containing particles is pressed through the gap. Another method for improving the properties of a magnetorheological liquid is known from EP-B 0 672 294. Here, contamination products are removed from the surface of the particles by abrasive methods, for example by adding abrasive additives. After the contamination products have been removed, the particles are immediately mixed into the solvent in order to prevent such contamination products, for example oxide layers, from re-forming.

EP-B 0 755 563 discloses magnetorheological materials in which at least 90% of the particles are enclosed by a protective layer. The protective layer is made from curable polymers, thermoplastic materials, nonmagnetic metals, ceramics or combinations thereof. The protective layer is applied in order to achieve a high maximum shear stress of the magnetorheological materials and preserve this during the period of use. EP-A 0 875 790 discloses a magnetorheological liquid which contains magnetizable particles coated with organic polymers. In this case, the magnetizable particles are coated in order to reduce the abrasiveness and the susceptibility to sedimentation.

In order to avoid sedimentation of the magnetizable particles, it is known from U.S. Pat. No. 6,547,986 to add a thickener to a magnetorheological lubricant. The amount of thickener is selected so as to improve the sedimentation behavior of the magnetizable particles.

If the suspensions containing magnetizable particles are subjected to shearing conditions in magnetic fields on the part of the user, changes in the suspension properties can take place and the basic viscosity may increase. Such changes are also referred to as in-use thickening (IUT) phenomena.

It is an object of the present invention to provide a method for conditioning a suspension containing magnetizable particles, by which the changes in the suspension properties known from the prior art, such as increasing viscosity or modified sedimentation properties, are avoided during use. In particular, it is an object of the invention to provide a method by which the in-use thickening phenomenon of suspensions containing magnetizable particles can be reduced when they are used in an apparatus. The term conditioning describes a process to which the suspensions containing magnetizable particles are subjected before the suspension or an apparatus using suspensions containing magnetizable particles is delivered to the user.

It is another object of the invention to provide a device for carrying out the method.

The object is achieved by a method for conditioning a suspension containing magnetizable particles, in which the suspension containing magnetizable particles is delivered through a gap in order to cause shearing of the suspension containing magnetizable particles. A magnetic field is applied in the gap so that the suspension containing magnetizable particles is sheared in the presence of the magnetic field.

A suspension containing magnetic particles in the context of the present invention generally contains magnetizable particles and liquid. It may optionally also contain additives.

The magnetizable particles may be any particles known from the prior art.

The magnetizable particles conventionally have an average diameter of between 0.1 and 500 μm, preferably between 0.1 and 100 μm and particularly preferably between 1 and 50 μm. The shape of the magnetizable particles may be uniform or nonuniform. In particular, they may be spherical, rod-shaped or needle-shaped particles. Magnetizable particles of substantially spherical configuration are preferably used. Approximately spherical particles may, for example, be obtained by atomizing molten metals (spray powder).

It is also possible to employ mixtures of magnetizable particles, in particular magnetizable particles with a different particle size distribution and/or made of different material.

The magnetizable particles are preferably selected from the group consisting of particles containing iron, particles containing nickel or particles containing cobalt. They are for example particles of iron, iron alloys, iron oxides, iron nitride, iron carbide, carbonyl-iron, nickel, cobalt, stainless steel, silicon steel, alloys or mixtures thereof. Particles of chromium dioxide, for example, may nevertheless also be contained.

The magnetizable particles may also have a coating; for example, iron powder coated with insulating or corrosion-inhibiting inorganic substances, for example silicates, phosphates, oxides, carbides or nitrites, with other metals or with at least one polymer may be used.

The magnetizable particles are preferably present in the form of carbonyl-iron powder (CEP). The carbonyl-iron powder is preferably produced by decomposition of iron pentacarbonyl. Various types of CEP are known to the person skilled in the art. Besides the hard CEP types obtained by thermal cleavage, reduced carbonyl-iron powders may also be used. Such powders are less abrasive and are mechanically softer. Surface-treated versions of hard and reduced CEP types are derived in a variety of ways. The most common treated carbonyl-iron powders are coated with silicate or phosphate. Other modifications are nevertheless also possible. A further criterion for differentiating between carbonyl-iron powders is the respective size distribution of particles, which can have a substantial effect on the application properties. The dispersed carbonyl-iron powders preferably have an average diameter in the range of 1-30 μm. In principle, all carbonyl-iron powder types are suitable. The specific choice is dictated by the conditions of use for the suspension containing magnetizable particles.

The magnetizable particles are preferable contained in the suspension containing magnetizable particles in a proportion of between 15 and 49 vol. %, particularly preferably between 20 and 48 vol. %, expressed in terms of the total volume of the suspension containing magnetizable particles.

For example, water or organic solvents are suitable as a base liquid in which the magnetizable particles are dispersed. Suitable organic solvents are for example poly-α-olefins, paraffin oils, hydraulic oils, ester oils, oils containing chlorinated aromatics, as well as chlorinated and fluorinated oils. Furthermore silicone oils, fluorinated silicone oils, polyethers, fluorinated polyethers and polyether polysiloxane polymers are also suitable. Likewise suitable as a base liquid are alcohols or amide derivatives of carboxylic acids with fewer than 5 carbon atoms as well as water-soluble amines. Suitable base liquids are for example ethanol, propranol, isopropanol, alkyl alcohol, mercaptoethanol, glycerol, ethylene glycol, propylene glycol, pentan-2,4-diol, hexan-2,5-diol, butan-1,3-diol, ethylene diamine, diethylene triamine, N-hydroxyethylpropylene diamine, morpholine, N-methyl morpholine, triethanolamine, formamide, acetamine and the like. Open or end group-terminated alcohol alkoxylates and ionic liquids are furthermore suitable. The aforementioned liquids may optionally also be mixed with one another in order to obtain suitable base liquids. Particularly preferably, however, the base liquid is a poly-α-olefin.

The suspension containing magnetizable particles may furthermore contain at least one additive. The additive is generally selected from the group consisting of thixotropic agents, viscosity modifiers, thickness, dispersants, surface-active additives, antioxidants, friction reducers/lubricants and corrosion protection agents.

Viscosity modifiers may, for example, be solvents or polymeric additives soluble in the base liquid, which alter the viscosity of the formulation. Suitable viscosity modifiers are for example polar solvents such as water, acetone, acetonitrile, molecular alcohols, amines, amides, DMF, DMSO, or polymeric additives, for example unmodified or modified polysaccharides, polyacrylates and polyureas.

If the suspension containing magnetizable particles contains additives acting as viscosity modifiers, then these are preferably contained in a concentration of 0.01-13 wt. %, particularly preferably 0.01-11 wt. %, in particular 0.05-10 wt. %, in each case expressed in terms of the total weight of the suspension containing magnetizable particles.

A thixotropic agent is an additive which sets up a flow limitation and thus counteracts sedimentation of the particles in the liquid of the suspension containing the magnetizable particles. The thixotropic agent is for example selected from the group consisting of natural and synthetic layered silicates of the smectite group (optionally hydrophobically modified layered silicates, for example of the montmorillonite type, as known from WO 01/03150 A1), silica gel (amorphous), disperse silicon dioxide (as known from U.S. Pat. No. 5,667,715), fibrous silicates (for example micronized sepiolites or attapulgites), carbon particles (as known from the U.S. Pat. No. 5,354,488) silica gel and polyureas (as known from DE 196 54 461 A1). Thixotropic agents based on polymeric carbohydrates may also be used, such as xanthan or galactomannan derivatives, guar derivatives and ionic or nonionic cellulose or starch ethers.

Examples of layered silicates which may be used are bentonite, montmorillonite, hectorite or synthetic layered silicates such as Laponite® from Rockwood Additives Ltd., and their modified variants. Furthermore, it is also possible to use layered silicates which are hydrophobically modified and therefore adapted to hydrophobic solvents such as poly-α-olefins and silicones.

If the suspension containing magnetizable particles contains additives acting as thixotropic agents, then these are preferably contained in a concentration of 0.01-10 wt. %, particularly preferably 0.01-5 wt. %, in particular 0.05-1 wt. %, in each case expressed in terms of the total weight of the suspension containing magnetizable particles.

A dispersant is an additive which improves redispersibility of the magnetizable particles in the liquid after their sedimentation and prevents their agglomeration. Suitable dispersants are for example polymeric dispersants such as polysaccharides, polyacrylates, polyesters, in particular of poly-hydroxystearic acid, alkyd resins, long-chained alkoxylates, as well as polyalkylene oxides, for example Pluronic® from BASF AG, which involve polyethylene oxide-polypropylene oxide-polyethylene oxide block copolymers and polypropylene oxide-polyethylene oxide-polypropylene oxide block copolymers. Other possible dispersants are anionic, cationic, amphoteric and nonionic surfactants, which are known to the person skilled in the art and need not be described in detail. Sugar surfactants and alcohol alkoxylates may be mentioned as examples of nonionic surfactants; carboxylic acid salts, for example oleates and stearates, alkyl sulfates, alkyl ether sulfates, alkyl phosphates, alkyl ether phosphates and alkyl sulfonates may be mentioned as examples of anionic surfactants, and alkyl amine oxides may be mentioned as examples of amphoteric or zwitterionic surfactants.

If the suspension containing magnetizable particles contains additives acting as dispersants, then these are preferably contained in a concentration of from 0.01 to 5 wt. %, particularly preferably from 0.05 to 1 wt. %, in each case expressed in terms of the total weight of the suspension containing magnetizable particles.

The suspension containing magnetizable particles may furthermore optionally contain other additives, for example friction reducers such as Teflon powder, molybdenum sulfide or graphite powder, corrosion inhibitors, anti-wear additives and antioxidants.

The dispersing efficiency can be increased significantly by shearing the suspension containing magnetizable particles in the presence of a magnetic field.

In contrast to shearing without a magnetic field as is known from the prior art, it has been found that shearing in the presence of the magnetic field leads to improved suspension properties. A more stable suspension can thereby be produced, which does not exhibit any increase in viscosity even if it is again subjected to shearing conditions in magnetic fields. The in-use thickening problem is reduced, and an improved redispersibility of the magnetizable particles is achieved.

The thermal stability of the suspension containing magnetizable particles under shearing in use is also improved.

It has furthermore been found that longer dispersing times during production of the suspension containing magnetizable particles, for example, cannot replace shearing in the presence of the magnetic field. Shearing the suspension containing magnetizable particles in the presence of the magnetic field leads to further improved properties compared with longer dispersing times.

Before the conditioning, the suspension containing magnetizable particles is usually prepared by a dispersing method. Shearing of the suspension containing magnetizable particles may be achieved by a gap through which the suspension containing magnetizable particles is delivered, i.e. the shearing gap, being bounded by at least two surfaces which move relative to one another. The relative movement of the at least two surfaces may for example be achieved by one surface being immobile and the second surface being moved.

As an alternative, it is also possible to move the two surfaces with different speeds or in opposite directions.

In order to prepare the suspension, for example, an Ultra-Turrax® or a ball mill is used. The Ultra-Turrax® is a stirring rod with a very rapidly rotating blade. The blade rotates at up to 24,000 rpm. This generates very high shear forces which lead to distribution of the magnetizable particles and optionally the dispersants and additives in the suspension to be produced. Such suspensions may also be prepared in a ball mill. A very fine dispersion is produced in this way. In order to further improve the properties of the dispersion thereby produced, conditioning by shearing in the presence of the magnetic field is subsequently carried out according to the invention.

In a preferred embodiment the magnetizable particles and the solvent, and optionally the additives, are likewise mixed in the presence of a magnetic field in the dispersing method. An improvement in the properties of the suspension containing magnetizable particles is likewise achieved by dispersing in the presence of the magnetic field.

Depending on the concentration of the magnetizable particles in the suspension, it is preferable for the strength of the magnetic field or the magnetic flux density in the shearing gap to be adjustable at the position of the shearing. Suitable magnetic flux densities preferably lie in the range of from 0.05 to 1.2 T. The strength of the magnetic field particularly preferably lies in the range of from 0.1 to 1 T.

In order to be able to adjust the magnetic flux density, it is preferable that electromagnets should be used for generating a magnetic field and that the magnetic field lines should be perpendicular to the shearing plane.

Shearing of the suspension containing magnetizable particles may be achieved by the gap, through which the suspension containing magnetizable particles is delivered, being bounded by at least two surfaces which move relative to one another.

If the gap is bounded by at least two surfaces which move relative to one another, it is preferable for one surface to be a stator plate and for the other surface to be formed by a rotor plate which faces the stator plate. The rotor plate preferably rotates about a central axis. The stator plate and the rotor plate are generally arranged so that the axis, about which the rotor plate rotates, extends perpendicularly to the stator plate.

In an alternative embodiment, the shearing gap is bounded by two coaxial cylinders inserted into one another. The shearing gap is in this case formed by the outer radius of the inner cylinder and the inner radius of the outer cylinder. The shearing in the gap is induced by moving the cylinders relative to one another with a rotational movement about the common axis. Two different arrangements may in principle be envisaged here: in a first variant the outer cylinder rotates, while the inner cylinder is stationary and is used for the torque measurement (Couette system). In the second embodiment, the outer cylinder is stationary while the inner cylinder is driven and torque measurement is simultaneously carried out (Searle system). The two cylinders lie on the same axis, which is arranged parallel to the shearing gap. During the shearing, the shearing gap is exposed to a magnetic field which is preferably perpendicular to the shearing plane. It is advantageous that the volume fillable with suspension should be formed predominantly by the shearing gap. The spacing of the bottoms or top surfaces of the inner and outer cylinders should be selected to be as small as possible, for example of the order of the height of the shearing gap. In the case of flowing through a cylinder arrangement, it should not be possible to form any dead volume not flowed through.

In an alternative embodiment, the shearing gap is bounded by a lateral cylinder surface and a screw shaft inserted into the cylinder (extruder principle). Extruders with two or more screw shafts may also be envisaged. The suspension containing magnetizable particles situated in the shearing gap is exposed to a magnetic field during the shearing, which ensures a significant increase in the viscosity of the suspension. The magnetic field may be applied either from the outside through the cylinder wall by suitable electromagnets or permanent magnets, or from the inside via the screw by suitable magnetic field generators.

In another alternative embodiment the gap, through which the suspension containing magnetizable particles is delivered, is a channel. The shearing is achieved by the channel having only a small cross section. A large pressure drop can therefore be produced in the channel. A shear stress acts on the suspension containing magnetizable particles owing to the pressure drop, so that shearing of the suspension is achieved. If the gap is designed in the form of a channel through which the suspension containing magnetizable particles flows, it is preferable for the cross section to be rectangular. In this case one magnet yoke may be arranged above the channel and the other may be arranged below it, so that a magnetic field is generated in the channel. As an alternative, it is of course also possible for the channel to have any other desired cross section. In contrast to a rectangular channel, however, the field distribution of the magnetic field is not ideal in this case.

The invention furthermore relates to a device for conditioning suspensions containing magnetizable particles, comprising at least one gap through which the suspension containing magnetizable particles flows in order to apply a shear force to the suspension containing magnetizable particles. The device furthermore contains at least one magnet for generating a magnetic field in the at least one gap.

In order to generate the magnetic field in the at least one gap, it is preferable for the at least one magnet to be arranged so that the poles of the magnet lie on opposite sides of the gap. In this way, a magnetic field is generated perpendicularly to the shearing plane in the gap.

In order to be able to apply the magnetic field on demand, and optionally also to be able to vary the strength of the magnetic field, it is preferable for the magnet to be an electromagnet. As an alternative, it is of course also possible to use at least one permanent magnet instead of at least one electromagnet. It is also possible to use both electromagnets and permanent magnets. If the magnetic field is adjustable, then the device according to the invention may for example be used for conditioning suspensions containing magnetizable particles with different compositions, in particular with different concentrations of magnetizable particles contained in this suspension. The strength of the magnetic field may in this case be adapted respectively to the suspension containing magnetizable particles to be conditioned.

In a first embodiment of the device according to the invention, the at least one gap is bounded by at least two plates which can be move relative to one another in order to apply the shear force to the suspension containing magnetizable particles. As already described above, it is possible here for the gap to be bounded by two opposing plates. One plate may in this case be fixed and the second may move. As an alternative, it is also possible to move the two plates with different speeds. For instance, the two plates may have different speeds or move in opposite directions.

In order to achieve a relative movement of the plates movable relative to one another, on the one hand it is possible to displace the plates relative to one another. In this case, for example, it is possible to leave one plate immobile and to arrange an endless belt, which revolves around at least two rollers, facing the plate so that the relative movement is generated.

It is particularly preferable, however, for at least one plate to be a rotor plate. The rotor plate rotates about a central rotation axis, the central rotation axis being arranged so that it extends perpendicularly to the second plate. A uniform gap width is ensured in this way. If both plates, which bound the gap, are formed as rotor plates, then the rotation axis for the two plates is preferably a common axis. In general, however, one plate is formed as a stator plate and one plate as a rotor plate. In this case, as described above, the rotation axis of the rotor plate preferably extends perpendicularly through the stator plate.

If the gap is bounded by two opposing rotor plates, then it is preferable for one rotor plate to rotate with a higher speed than the other plate or for the two rotor plates to rotate in opposite directions.

Preferably the surfaces of the rotor plate and the stator plate, or of the second rotor plate, which bound the gap each have a plane plate surface, respectively have a plane and a conical plate surface or each have a conical plate surface. If one plate surface is plane and one plate surface is designed conically, or if both plate surfaces are designed conically, the gap width decreases toward the rotation axis.

In order to record the energy input, it is necessary to record both the rotational speed and the torque of the rotor plate or the cylinder arrangement. A torque measurement is required if the rotational speed is set, and a rotational speed measurement is required if the torque is set. Preferably, both measurement quantities are always logged continuously. With the given volume of the shear cell and the dimensions of the shearing gap/shearing gaps, the specific energy input can be calculated from these measurement quantities.

The described shear cells heat up owing to the high specific energy input. For this reason it is preferable to thermostat the shear cell (regardless of which version). This may be achieved by full immersion of the shear cell in a thermostatted bath or a temperature-controlled kiln. As an alternative it is possible to provide cooling channels, through which a suitable refrigerant circulates, in the housing of the shear cell. This variant has the advantage that cooling can take place relatively close to the shearing gaps. It is furthermore possible for the shear cell to receive a cooling air flow.

In a second embodiment of the device designed according to the invention, the at least one gap, in which the shear force is applied to the suspension containing magnetizable particles, is a flow channel through which the suspension containing magnetizable particles flows. The shear force, which is exerted on the suspension containing magnetizable particles, depends in this case on the flow rate of the suspension in the channel and the pressure drop. In order to exert a sufficiently great pressure drop or a sufficiently great shear on the suspension containing magnetizable particles, it is preferable for the gap to have a height in the range of from 0.08 to 5 mm. A smaller gap height leads to a greater shear rate exerted on the suspension if the selected throughput is the same. Besides the height, the pressure reduction in the gap also depends on the length of the gap. The greater is the ratio of length to height or length to diameter in the gap, the greater is the pressure drop. This means that the channel required to achieve the same pressure drop is shorter when the gap height decreases.

In order to generate the magnetic field in the gap, in the case of a flow channel with a rectangular cross section the magnets are arranged above and below the channel, so that the channel is permeated by the magnetic field. The magnets may be permanent magnets or electromagnets. In order to generate the magnetic field, the magnets are arranged so that the north pole of the magnet is arranged on one side of the channel and the south pole of the magnet is arranged on the other side. If a plurality of magnets are arranged next to one another over the length of the flow channel, then it is possible for the same poles to be respectively arranged on one side of the channel so that the magnetic field is balanced over the entire channel length. As an alternative, however, it is also possible for example to arrange the north and south poles of the magnets alternately on one side of the channel and the opposite poles correspondingly on the other side of the channel, so that the magnetic field in the channel changes from pole pair to pole pair.

In the channel arrangement, devices for determining the throughput and the pressure drop over the channel are preferably provided in order to determine the shear energy input. In an extruder arrangement, the torque of the screw and the throughput or the rotational speed of the screw are preferably recorded.

In order to achieve sufficient conditioning of the suspension containing magnetizable particles, the device generally furthermore comprises a storage vessel in which the suspension containing magnetizable particles is contained. The suspension containing magnetizable particles is generally delivered from the storage vessel through the at least one gap with the aid of a pump. In order to achieve sufficient conditioning, it is preferable to make the suspension containing magnetizable particles flow through the gap several times. The number of passes of the suspension containing magnetizable particles through the gap will in this case depend on the energy input required for the conditioning process.

Besides reducing the in-use thickening, the redispersibility is also improved by conditioning the suspension containing magnetizable particles. For example, a suspension containing magnetizable particles conditioned according to the invention can be redispersed after a storage time of 20 days with substantially less work compared with an unconditioned suspension containing magnetizable particles. The difference with a storage time of 20 days is approximately a factor of 5. This means that the suspension containing magnetizable particles conditioned according to the invention can be redispersed with a workload which is a factor of 5 less than that of an unconditioned suspension containing magnetizable particles.

Exemplary embodiments of the invention are represented in the drawings and will be explained in more detail in the following description.

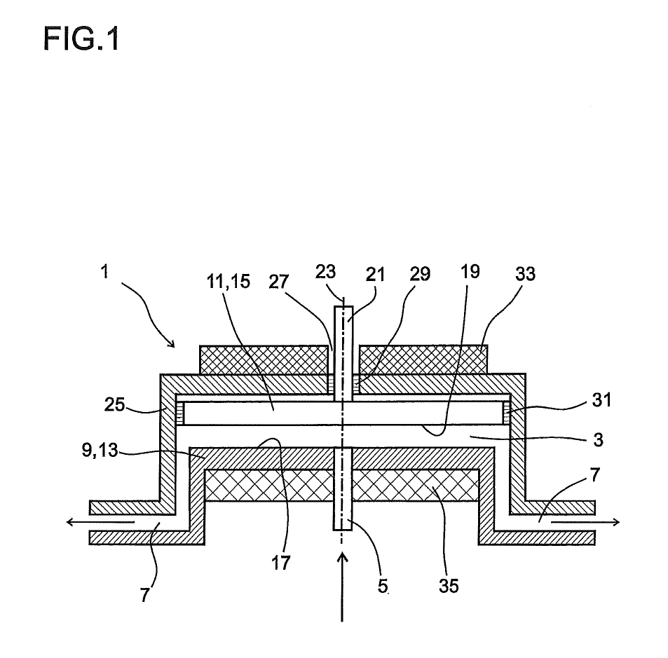

FIG. 1 shows a shear cell designed according to the invention with the rotor plate,

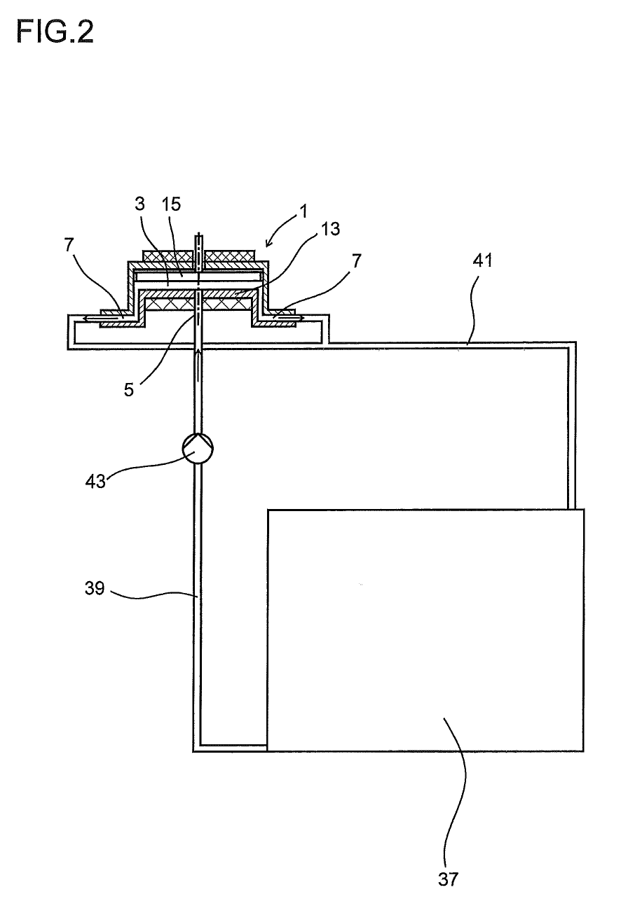

FIG. 2 shows a conditioning system with a shear cell according to FIG. 1,

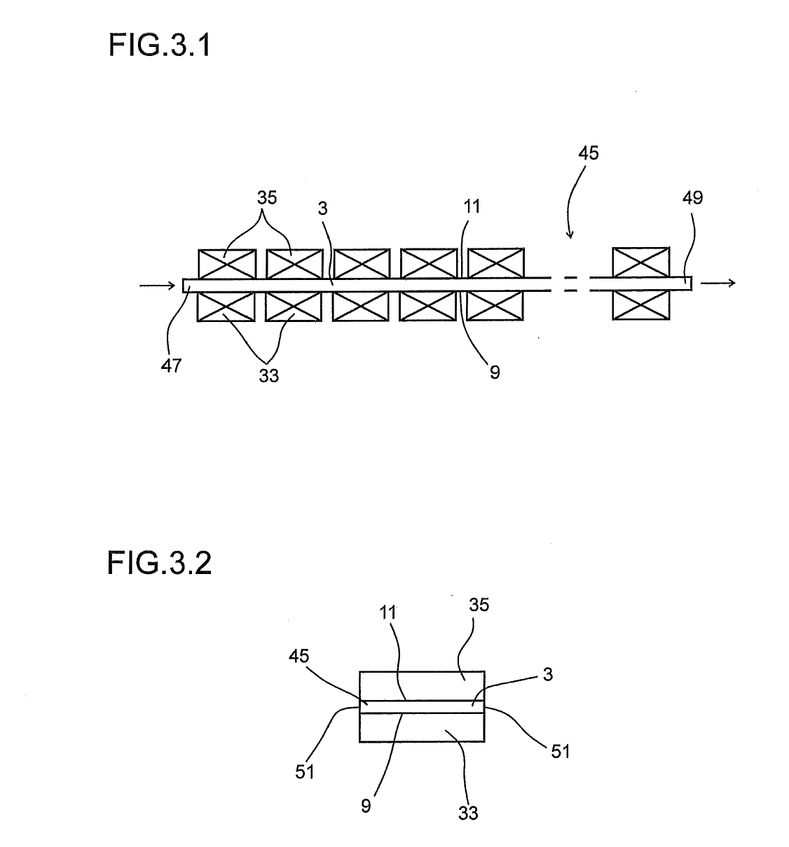

FIG. 3.1 shows a flow channel for conditioning, designed according to the invention, in longitudinal section,

FIG. 3.2 shows the flow channel according to FIG. 3.1 in cross section

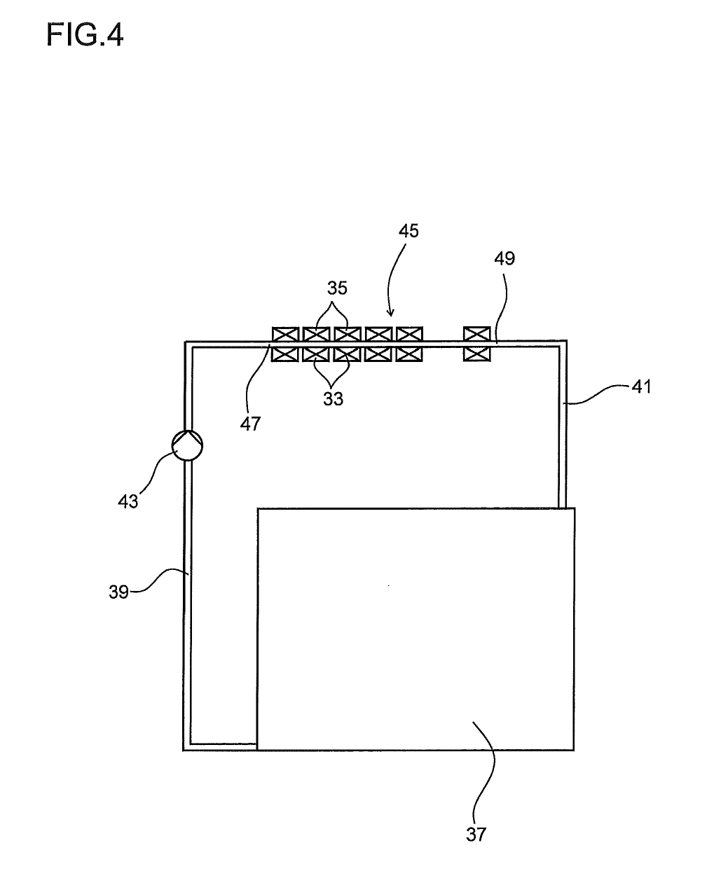

FIG. 4 shows a conditioning system with a flow channel according to FIGS. 3.1 and 3.2,

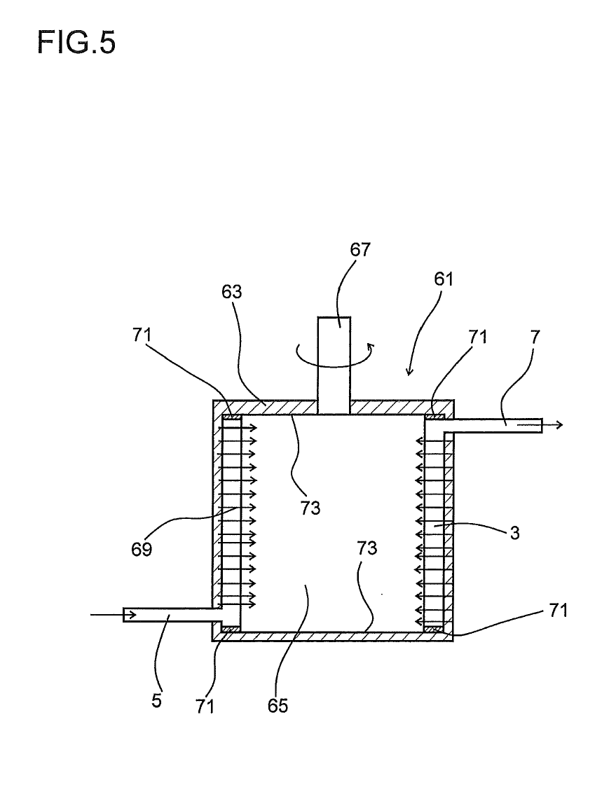

FIG. 5 shows a shear cell designed according to the invention with a cylinder geometry in a first embodiment,

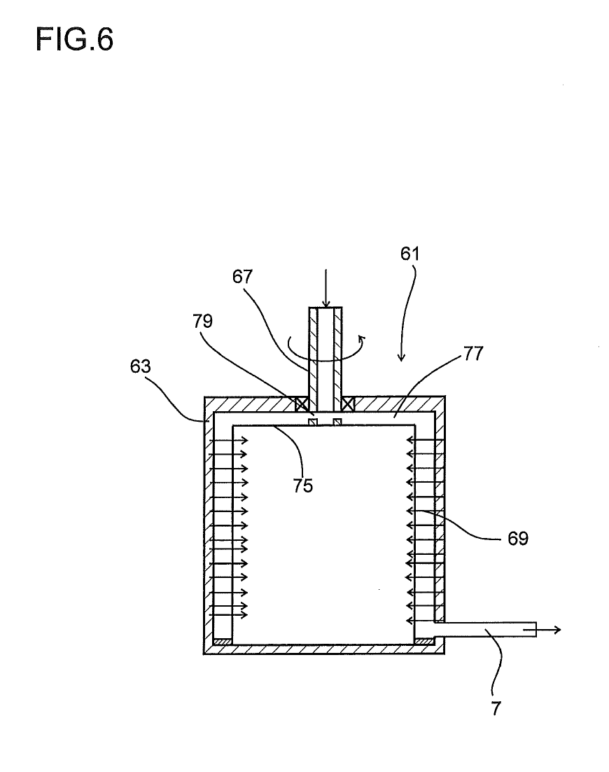

FIG. 6 shows a shear cell designed according to the invention with a cylinder geometry in a second embodiment, and

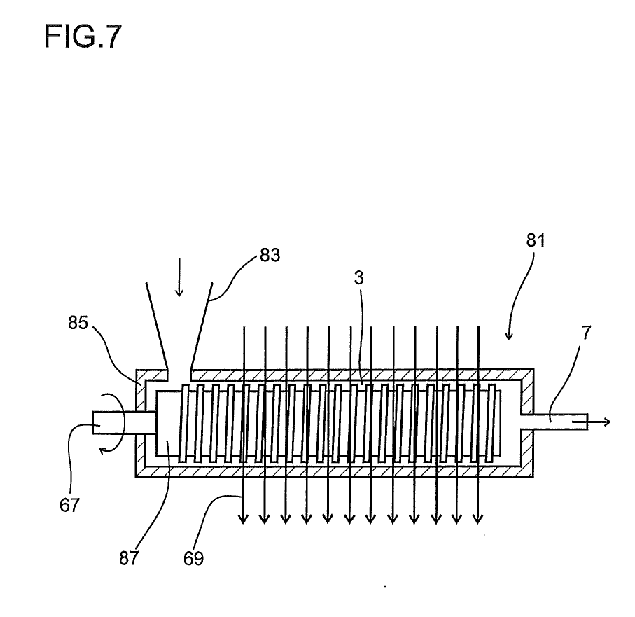

FIG. 7 shows a shear cell designed according to the invention with an extruder structure.

FIG. 1 represents a shear cell designed according to the invention with the rotor plate.

A shear cell 1 comprises a gap 3, through which a suspension containing magnetizable particles flows. The suspension is sheared in the gap 3. The suspension containing magnetizable particles is supplied to the gap 3 through an inlet channel 5. In the embodiment of the shear cell 1 as represented in FIG. 1, the inlet channel 5 is arranged centrally. The suspension containing magnetizable particles flows through the inlet channel 5 into the gap 3, flows through the gap 3 and is removed again from the shear cell 1 through one or more outlet channels 7. In the embodiment represented here, the shear cell 1 comprises two outlet channels 7. It is however also possible for the shear cell 1 to comprise only one outlet channel 7 or even more than two outlet channels 7.

The gap 3 is bounded by a first plate 9 and a second plate 11. The first plate 9 in the embodiment represented here is a stator plate 13. The inlet channel 5 passes through the stator plate 13 in its middle.

The second plate 11, which is designed as a rotor plate 15, faces the stator plate 13. In this way, the gap 3 is bounded by a surface 17 of the stator plate 13 and a surface 19 of the rotor plate 15.

The surface 17 of the stator plate 13 and the surface 19 of the rotor plate 15 may be plane, as represented in FIG. 1. Furthermore, it is also possible for the surface 17 of the stator plate 13 and the surface 19 of the rotor plate 15 to be designed conically. The cone tip in this case lies in the middle of the surface 19 of the rotor plate 15 and the surface 17 of the stator plate 13 respectively, i.e. at the position where the rotation axis 23 passes through the rotor plate 15 and the stator plate 13. Furthermore, it is also possible for the surface 17 of the stator plate 13 to be plane and for the surface 19 of the rotor plate 15 to be conical, or for the surface 19 of the rotor plate 15 to be plane and for the surface 17 of the stator plate 13 to be conical. If the surface 17 of the stator plate 13 or the surface 19 of the rotor plate 15 are designed conically, then the vertex angle of the cone preferably lies in the range of from 0.3 to 6°.

The rotor plate 15 is connected to a rotor shaft 21. The rotor shaft 21 is in turn connected to a drive (not shown). A rotational movement is imparted to the rotor plate 15 by the drive and the rotor shaft 21.

A rotation axis 23 extends centrally through the rotor shaft 21. The rotation axis 23 is aligned so that it extends perpendicularly through the rotor plate 15 and perpendicularly through the stator plate 13. A uniform gap width of the gap 3 is achieved in this way.

So that no suspension containing magnetizable particles is expelled from of the gap 3 during operation of the shear cell 1, the shear cell 1 furthermore comprises a housing 25. The housing 25 encloses the stator plate 13, the rotor plate 15 and the gap 3.

In the embodiment represented here an opening 27 is formed in the housing 25, through which the rotor shaft 21 of the rotor plate 15 extends. The rotor shaft 21 is preferably supported in the opening 27 of the housing 25 by a bearing (not represented in detail in FIG. 1). Any desired rolling bearing known to the person skilled in the art is suitable as a bearing. For example ball bearings, needle bearings, cylinder bearings or the like may be used. The interior of the housing 25 is furthermore sealed off from the surroundings by a sealing element 29 which is accommodated in the opening 27, between the rotor shaft 21 and the housing 25. The sealing element 29 may for example be an O-ring, a shaft sealing ring, a quad ring, a labyrinth steel or a sliding ring seal. Any other desired seal known to the person skilled in the art, which seals a rotating element from a stationary element, is also possible.

In order to prevent suspension containing magnetizable particles from flowing out of the gap 3 around the rotor plate 15 instead of to the outlet channels 7, in the embodiment represented here the rotor plate 15 is enclosed by a second sealing element 31. The sealing is achieved by the second sealing element 31 bearing on the one hand on the outer circumference of the rotor plate 15 and on the other hand on the housing 25. Like the sealing element 29, the second sealing element 31 may be an O-ring, a shaft sealing ring, a quad ring, a labyrinth steel or a sliding ring seal. Any other desired seal known to the person skilled in the art, which seals a rotating element from a stationary element, is also possible.

In order to condition the suspension containing magnetizable particles, it is supplied to the gap 3 through the inlet channel 5. A shear force is exerted on the suspension containing magnetizable particles owing to a rotational movement of the rotor plate 15. At the same time, the gap is permeated by the magnetic field. To this end there is a first yoke 33 of a magnet on the other side of the rotor plate 15 from the gap, and its second yoke 35 on the other side of the stator plate 13 from the gap 3. The magnet may be a permanent magnet or an electromagnet. The magnet is preferably an electromagnet. The first yoke 33 and the second yoke are poled so that a magnetic field is formed between the first yoke 33 and the second yoke 35. This magnetic field then permeates the gap 3. In this way, the shearing of the suspension containing magnetizable particles in the gap 3 takes place in the presence of a magnetic field. The strength of the applied magnetic field is selected so that the magnetic flux density in the shearing gap lies in the range of from 0.05 to 1.2 T, preferably in the range of from 0.1 to 1.2 T, particularly in the range of from 0.2 to 0.8 T.

A conditioning system having a shear cell according to FIG. 1 is represented in FIG. 2.

In addition to the shear cell 1, the conditioning system comprises a storage container 37, a supply line 39, a return line 41 and a pump 43. The pump 43 is arranged in the supply line 39. The suspension containing magnetizable particles is supplied to the inlet channel 5 and into the shear cell 1 by the pump 43. The suspension containing magnetizable particles subsequently flows through the gap 3 between the stator plate 13 and the rotor plate 15, and emerges from the shear cell 1 through the outlet channels 7. The outlet channels 7 open into the return line 41, through which the suspension containing magnetizable particles is delivered back to the storage container 37. In order to achieve sufficient conditioning, it is necessary to pump the content of the storage container 37 through the shear cell 1 several times.

FIG. 3.1 represents a flow channel for conditioning, designed according to the invention, in longitudinal section.

In the embodiment represented in FIG. 3.1, the gap 3 is formed by a flow channel 45. The flow channel 45 is bounded here by a first plate 9 on its lower side and by a second plate 11 on its upper side. For conditioning, the suspension containing magnetizable particles is supplied to the flow channel 45 through an inlet 47. The suspension containing magnetizable particles re-emerges from the flow channel 45 through an outlet. Owing to the wall friction on the first plate 9 and the second plate 11 when flowing through the flow channel 45, and owing to friction of the magnetizable particles with one another, a shear force is exerted on the suspension containing magnetizable particles while flowing through the flow channel 45. Since according to the invention the shearing takes place in the presence of a magnetic field, the flow channel 45 forming the gap 3 is permeated by a magnetic field. To this end first yokes 33 of magnets are respectively arranged on the opposite side of the first plate 9 from the gap 3 and their second yokes 35 are arranged on the opposite side of the second plate 11 from the gap 3. Likewise as in the shear cell represented in FIG. 1, the magnets may be permanent magnets or electromagnets. The yokes 33, 35 are respectively poled so that a magnetic field is formed between two opposing yokes 33, 35. According to the invention it is possible for there to be only one magnet along the flow channel 45, in which case the first yoke 33 of the magnet bears on the first plate 9 and the second yoke 35 of the magnet bears on the second plate 11. Furthermore, it is nevertheless also possible for a plurality of magnets to be arranged next to one another as represented in FIG. 3.1. Here, on the one hand, it is possible for the first yoke 33 and the second yoke 35 of neighboring magnets respectively to be poled in the same way, so that the magnetic field is equally directed over the entire flow channel 45. As an alternative, it is also possible for the first yoke 33 and the second yoke 35 of neighboring magnets respectively to be poled differently, so that the magnetic field alternates and is respectively directed oppositely between two neighboring magnets.

In order to obtain a uniform magnetic field in the flow channel 45, it is preferable for it to have a rectangular cross section as represented in FIG. 3.2. A lateral boundary of the flow channel 45 is in this case formed by sidewalls 51. The flow channel 45 preferably has only a small height compared with its width.

A more shortly designed flow channel 45 may, for example, be produced if additional shearing is achieved by moving a bounding wall. This is possible for example by the second plate 11, which bounds the upper side of the flow channel 45, being designed in the form of a revolving belt. In this case, the boundary of the flow channel formed by the revolving belt may move relative to the first plate 9. An additional shear force is exerted. Furthermore, it is also possible for both the first plate 9 and the second plate 11 to be mobile, in which case it is preferable for the first plate 9 and the second plate 11 to move with different speeds or in opposite directions. In this case as well, it is preferable for the first plate 9 and the second plate 11 respectively to be designed in the form of an endless belt, each of which revolves about at least two shafts by which the first plate 9 and second plate 11 designed as belts are driven.

Besides the embodiment represented in FIGS. 3.1 and 3.2, in which the flow channel 45 has a constant height over its entire length, it is also possible for the height of the flow channel 45 to vary over its length. For example, it is possible for the height of the flow channel 45 to increase or decrease over its length. It is furthermore possible for sections, in which the height of the flow channel 45 increases and then decreases again, to alternate. It is also possible for example for the plate 9 and the second plate 11, which bound the flow channel 45, to be designed in a corrugated fashion so that the flow channel 45 extends in an undulating fashion. It is also possible, when the first plate 9 and the second plate 11 are designed in a corrugated fashion, for the peaks of the corrugations to face one another so that a continual increase and decrease in the channel height is achieved. Any other profile, known to the person skilled in the art, is also possible for the channel through which the suspension containing magnetizable particles flows.

The ratio of height to length of the flow channel and the magnetic flux density are preferably selected so that a pressure drop of at least 5 bar is achieved in the channel. The pressure drop preferably lies in the range of from 10 to 200 bar, particularly in the range of from 50 to 100 bar.

FIG. 4 represents a conditioning system having a flow channel according to FIGS. 3.1 and 3.2. Like the conditioning system represented in FIG. 2, the conditioning system comprises a storage container 37, a supply line 39, a return line 41 and a pump 43. The supply 39 is connected to the inlet 47 of the flow channel 45. By means of the pump 43, the suspension containing magnetizable particles is pumped from the storage container 37 into the flow channel 45. The suspension containing magnetizable particles leaves the flow channel through the outlet 49 into the return line 41, via which it returns into the storage container 47. For the conditioning, a magnetic field is generated in the flow channel 45 by means of the magnets respectively formed by the first yokes 33 and second yokes 35. Sufficient conditioning is achieved by the suspension containing magnetizable particles from the storage container 37 passing through the flow channel 45 several times.

Besides the shear cell with a rotor plate and the flow channel according to FIGS. 3.1 and 3.2, the shear cell may also assume other forms which are suitable for shearing a suspension. Other suitable forms are, for example, shear cells with a cylinder geometry wall with an extruder structure.

A shear cell with cylinder geometry in a first embodiment is represented in FIG. 5.

A shear cell with cylinder geometry 61 comprises a stationary housing 63. The stationary housing 63 encloses a rotatable cylinder 65. To this end, the cylinder 65 is connected to a shaft 67 which passes through the housing. The shaft 67 is connected to a drive.

The gap 3 is formed between the cylinder 65 and the stationary housing 63. The suspension containing magnetizable particles flows through an inlet channel 5 into the gap 3. The suspension flows through the gap 3 and emerges from the shear cell 61 via the outlet channel 7.

According to the invention, a magnetic field 69 is applied so that the field lines, which are symbolized by arrows here, are aligned perpendicularly to the flow direction of the suspension in the gap. In order to generate the magnetic field 69, for example, it is possible to surround the stationary housing 63 with a coil. In order to achieve an equally directed magnetic field, it is preferable to arrange one yoke of the magnet outside the housing and the second yoke of the magnet inside the cylinder 65.

So that the suspension containing magnetizable particles flows only through the gap 3, which surrounds the rotatable cylinder 65 on its surface and which is therefore likewise formed cylindrically, the gap 3 is closed at its ends by suitable sealing elements 71. This prevents suspension containing magnetizable particles from entering between the end faces 73 of the rotatable cylinder 65 and the housing 63.

FIG. 6 represents a shear cell with cylinder geometry in a second embodiment.

The shear cell 61 represented in FIG. 6 differs from the shear cell represented in FIG. 5 in that the supply of the suspension containing magnetizable particles takes place through the shaft 67. To this end, the shaft 67 is designed as a hollow shaft. A gap 77, through which the suspension containing magnetizable particles flows, is formed between the upper end face 75 of the cylinder 65 and the housing 63. The suspension flows along the gap 77 into the cylindrical gap 3, which is permeated by the magnetic field 69. The outlet channel 7 lies on the opposite side of the housing 63 from the shaft 67. As an alternative, a reversed flow direction is also possible. In this case, the suspension is supplied through the outlet channel 7 and leaves the shear cell 61 through the shaft 67.

So that the suspension containing magnetizable particles passes from the shaft 67 designed as a hollow shaft into the gap 77, at least one opening 79 is formed in the shaft 67. The opening 79 may for example be a bore.

A conditioning system, which is operated with a shear cell having cylinder geometry as represented in FIG. 5 or 6, is constructed similarly as a conditioning system with a shear cell having a rotor plate or flow channel. In the case of the flow system represented in FIGS. 2 and 4, this means that the represented shear cell or the represented flow channel is merely replaced by the corresponding shear cell with cylinder geometry.

FIG. 7 shows a shear cell with an extruder structure.

A shear cell 81 with an extruder structure, as represented in FIG. 7, is used in particular to disperse particles in highly viscous media.

The individual components are added to the suspension either separately or together through a funnel 83. If the shear cell 81 with an extruder structure is used not for dispersing the particles but only for conditioning, the suspension already containing magnetizable particles will be delivered through the funnel 83.

The shear cell 81 with an extruder structure comprises a stationary housing 85, in which an extruder screw 87 is accommodated. The gap 3, through which the suspension containing magnetizable particles flows and which is permeated by the magnetic field 69 for the conditioning, is formed between the extruder screw 87 and the housing 85.

If the shear cell 81 with an extruder structure is used to disperse particles in highly viscous media, then simultaneous dispersion and conditioning of the suspension take place while the latter flows through the shear cell 81 with an extruder structure.

So that the highly viscous medium flows through the extruder, the extruder screw is mounted rotatably and is driven by means of a shaft 67. The material supplied through the funnel 83 is transported with the aid of the extruder screw 87 along the gap 3 to the outlet channel 7. At the outlet channel 7, the finely dispersed and conditioned suspension containing magnetizable particles emerges from the shear cell 81 with an extruder structure.

In the shear cell 81 with an extruder structure, the application of the magnetic field 69 is carried out for example according to the application in the shear cell 61 with cylinder geometry, in which the housing 85 is enclosed by a coil that generates the magnetic field. As an alternative, it is also possible to arrange permanent magnets on or in the cylinder wall and/or the screw.

A conditioning system, in which a shear cell 81 with an extruder structure is used, is likewise constructed according to the conditioning system with a shear cell 1 having a rotor plate or flow channel as represented in FIGS. 2 and 4, the shear cell 1 with a rotor plate or the flow channel being replaced by the shear cell 81 with an extruder structure.

If the shear cell 81 with an extruder structure is used to disperse particles in highly viscous media, then as an alternative it is also possible for the starting materials from the storage container to be delivered through the funnel 83 and for the finely dispersed and conditioned suspension, which flows out of the outlet channel 7, to be fed into a further reservoir. It is possible for the suspension contained in the reservoir to be supplied through the funnel 83 into the extruder, in which case some of the already dispersed suspension is respectively mixed with the starting materials in the extruder. As an alternative, it is also possible to condition the suspension further in another shear cell.

### EXAMPLES

A suspension which contains 90 wt. % of carbonyl-iron powder, 9.05 wt. % of poly-α-olefin, 0.45 wt. % of modified attapulgite (Attagel 50 from Engelhard modified with Arquad C2-75 from Akzo-Nobel) and 0.5 wt. % of alkyd resin, is used for the following examples.

### Comparative Example

A shear cell as represented in FIG. 1, with a gap height of 2 mm and with a rotor plate outer diameter of 300 mm, is operated in order to condition a suspension containing magnetizable particles without applying a magnetic field. The rotational speed of the rotor plate is 400 l/min. The shear stress exerted on the suspension containing magnetizable particles is 1.1 kPa with a shear rate of 6283 l/s. The desired energy input of 3e10 J/m³ gives a conditioning time of 22.8 h for a suspension volume of 10 liters.

### Example 1

A magnetic field of 0.5 T is applied to the shear cell of the comparative example. The rotor plate is operated with a rotational speed of 35 l/min. A shear stress of 25.4 kPa is applied to the suspension containing magnetizable particles with a shear rate of 550 l/s. The energy input of 3e10 J/m³ is achieved after a conditioning time 11 h with a production volume of 10 liters. It can be seen that, for an identical energy input, a very much shorter shearing time with a reduced shear rate can be achieved by applying the magnetic field.

### Example 2

A shear cell as represented in FIG. 1 is used. The outer diameter of the rotor plate is 150 mm and the height of the gap is 1 mm. The rotor plate is operated with a rotational speed of 35 l/min. A shear stress of 25.5 kPa with a shear rate of 550 l/s is applied to the suspension containing magnetizable particles, which flows through the gap. A volume throughput of 0.11 l/h and a total volume of suspension containing magnetizable particles equal to 10 l give a conditioning time of 87.7 h in order to achieve an energy input of 3e10 J/m³.

When the conditioning as carried out in Examples 1 and 2 takes place in the presence of a magnetic field, the work for redispersing after a storage time of 20 days is found to be reduced by a factor of 5.

### Example 3

Conditioning is carried out in a flow channel as represented in FIG. 3. To this end a flow channel with a gap height of 2 millimeters and a length of 1200 millimeters is used. The magnetic field generated by the magnets surrounding the gap is approximately 0.5 T. In order to achieve an energy input of 3e10 J/m³, the suspension containing magnetizable particles must flow 1000 times through the channel with a pressure drop of 300 bar. In contrast, a number of passes equal to 10,000 is required with a pressure drop of only 30 bar.

A gap width of 20 millimeters, a height of 2 millimeters and a channel length of 1200 millimeters give a shear rate of 8700 l/s for a total volume throughput of 10 l in 24 hours when flowing through the gap one thousand times.

### Example 4

A shear cell is used which differs from the shear cell represented in FIG. 1 in that the rotor plate lies between two stator plates which are arranged parallel. The shear cell thus has two shearing gaps, one above the rotor plate and one below it. The rotor plate and stator plates are arranged coaxially and a magnetic field is introduced into the shearing gap by two permanent magnets or electromagnets arranged above and below the stator plates. They have a central bore for feeding through the drive shaft onto the rotor plate. The stator plates have a maximum diameter of 40 mm, and the rotor plate has a radius of 19 mm. In the region of the drive axis, the rotor plate is sealed off from the stator plates and supported. The resultant shearing gaps therefore have a minimum radius of 5 mm and a maximum radius of 19 mm. The height of the shearing gap is 1 mm in each case. The shear cell is typically operated with a rotational speed of 100 rpm, resulting in a maximum shear rate of 200 l/s in the gaps. A magnetorheological liquid was sheared in this cell with a resulting torque of 0.9 Nm, which was measured on the rotor axis. The frictional torque of the seals is already taken into account. With the given rotational speed and the resulting torque, a specific energy input of 3e10 J/m³ is achieved after 1.8 hours. The power input is 10 watts in this case. For conditioning larger volumes, the shear cell is to be filled a corresponding number of times.

When the conditioning as carried out in Example 4 takes place in the presence of a magnetic field, the work for redispersing after a storage time of 20 days is found to be reduced by a factor of 5.

### LIST OF REFERENCES

1 shear cell
3 gap
5 inlet channel
7 outlet channel
9 first plate
11 second plate
13 stator plate
15 rotor plate
17 surface of the stator plate 13
19 surface of the rotor plate 15
21 rotor axis
23 rotation axis
25 housing
27 opening
29 sealing element
31 second sealing element
33 first yoke
35 second yoke
37 storage container
39 supply line
41 return line
43 pump
45 flow channel
47 inlet
49 outlet
51 sidewall
61 shear cell with cylinder geometry
63 stationary housing
65 cylinder
67 shaft
69 magnetic field
71 sealing element
73 end face of the cylinder
75 upper end face of the cylinder
77 gap
79 opening
81 shear cell with extruder structure
83 funnel
85 housing
87 extruder screw

1-19. (canceled)

20. A method comprising: providing a suspension comprising magnetizable particles; and delivering the suspension through a gap (3), wherein a magnetic field is applied in the gap, such that the suspension is sheared in the gap in the presence of the magnetic field to form a conditioned suspension.

21. The method according to claim 20, further comprising adjusting the magnetic field strength.

22. The method according to claim 20, wherein the gap (3) is bounded by at least two surfaces which move relative to one another.

23. The method according to claim 20, wherein the gap (3) is bounded by a stator plate (13) and a rotor plate (15) which faces the stator plate (13) and rotates about a central rotation axis (23).

24. The method according to claim 20, wherein the gap (3) is bounded by a rotatable cylinder (65) and a stationary housing (63) enclosing the rotatable cylinder (65).

25. The method according to claim 20, wherein the suspension further comprises a base liquid and optionally additives.

26. The method according to claim 20, wherein the magnetizable particles are present in the suspension in an amount of at least 15 vol. % based on total volume of the suspension.

27. The method according to claim 20, wherein the magnetizable particles comprise carbonyl-iron powder.

28. The method according to claim 25, wherein the base liquid comprises a poly-α-olefin.

29. The method according to claim 20, further comprising mixing the magnetizable particles, a polymer, a solvent and one or more optional additive to form the suspension containing magnetizable particles before shearing in the presence of the magnetic field.

30. A device for conditioning suspensions containing magnetizable particles, the device comprising a gap (3) through which the suspension containing magnetizable particles flows and in which a shear force is applied to the suspension containing magnetizable particles, wherein the device furthermore contains a magnet for generating a magnetic field in the gap (3).

31. The device according to claim 30, wherein the magnet comprises an electromagnet.

32. The device according to claim 30, wherein the gap (3) is bounded by at least two plates (9, 11) which can be moved relative to one another to apply a shear force to the suspension containing magnetizable particles.

33. The device according to claim 32, wherein at least one of the at least two plates movable relative to one another comprises a rotor plate (15), which is rotatable about a central rotation axis (23).

34. The device according to claim 33, wherein the rotor plate (15) is arranged facing a stator plate (13), such that the gap (3) is bounded by the rotor plate (15) and the stator plate (13).

35. The device according to claim 34, wherein the rotor plate (15) is arranged facing a second rotor plate, so that the gap is bounded by the two opposing rotor plates.

36. The device according to claim 34, wherein the rotor plate (15) and the stator plate (13) have surfaces selected from each a plane plate surface (17, 19), respectively a plane and a conical plate surface (17, 19) or each have a conical plate surface (17, 19).

37. The device according to claim 30, wherein the gap (3) comprises a flow channel (45), through which the suspension containing magnetizable particles flows.

38. The device according to claim 30, wherein the gap (3) has a height of 0.2 mm to 10 mm.

39. The device according to claim 30, further comprising a cooling system for dissipating heat generated by shearing.
